(19) United States
(12) Patent Application Publication
(10) Pub. No.: US 2026/0361125 A1
(43) Pub. Date: Nov. 12, 2026

(54) MACHINE LEARNING DRIVEN BUILDING ENERGY OPTIMIZATION WITH REAL-TIME CONTROL

(71) Applicants: Charles Han, San Francisco, CA (US); Karthik Krishnamurthy, Mountain View, CA (US); Sharad Mehrotra, Irvine, CA (US); Nalini Venkatasubramanian, Irvine, CA (US)

(72) Inventors: Charles Han, San Francisco, CA (US); Karthik Krishnamurthy, Mountain View, CA (US); Sharad Mehrotra, Irvine, CA (US); Nalini Venkatasubramanian, Irvine, CA (US)

(21) Appl. No.: 19/673,847

(22) Filed: May 11, 2026

Related U.S. Application Data
(60) Provisional application No. 63/803,178, filed on May 9, 2025.

(51) Int. Cl. H02J 13/12; G05B 13/02; H02J 3/32; H02J 3/38; H02J 7/35; H02J 13/10; H02J 101/24; H02J 105/12

(52) U.S. Cl. CPC H02J 13/12; G05B 13/0265; H02J 3/32; H02J 3/38; H02J 7/35; H02J 13/10; H02J 2101/24; H02J 2105/12

(57) ABSTRACT

Machine learning driven building energy optimization with real-time control is provided. A method includes receiving, via a building API, building data from building management systems and sensor networks, and storing the building data in a data lake. A data management middleware transforms the building data into semantic observations comprising occupancy data, location data, or activity data. Machine learning models generate predictions comprising predicted occupancy at one or more spatial granularities, predicted heating or cooling gradients based on environmental conditions, thermal properties, and occupancy data, or predicted energy consumption patterns. Energy optimization applications/services determine optimal building control settings based on the predictions and external data comprising utility pricing data or weather data. Virtual system controllers generate vendor-neutral control commands based on the optimal settings. The vendor-neutral commands are translated into vendor-specific commands and transmitted via the building API to the building management systems.

### CROSS-REFERENCE TO RELATED APPLICATIONS/INCORPORATION BY REFERENCE

This application claims priority to U.S. Provisional Patent Application Ser. No. 63/803,178 filed on May 9, 2025, the entire content of which is hereby incorporated herein by reference.

### TECHNICAL FIELD

The disclosure relates to building energy management and more particularly, to technologies for machine learning driven optimization of building systems with real-time control.

### BACKGROUND

Buildings consume a significant portion of global energy, with subsystems such as heating, ventilation, and air conditioning (HVAC), lighting, water heating, and refrigeration contributing to overall energy demand. Building management systems have been developed to monitor and control these subsystems. Such systems may collect data from sensors deployed throughout a building and use this data to manage building operations. However, buildings often contain equipment from multiple vendors, each with proprietary interfaces and communication protocols. This heterogeneity can create challenges for unified monitoring and control. Additionally, building occupancy and usage patterns can vary significantly over time, and external factors such as weather conditions and utility pricing can affect optimal operating strategies. There remains a need for improved approaches to building energy management.

### SUMMARY

In various embodiments of the disclosure, a computer-implemented method for building energy and performance optimization is described. The method includes receiving, via a building application programming interface (API), building data from a plurality of building management systems and sensor networks associated with a building. The method further includes storing the building data in a data lake. The method also includes transforming, by a data management middleware, the building data into semantic observations, the semantic observations comprising one or more of occupancy data, location data, and activity data. Additionally, the method involves generating, by one or more machine learning models trained on the semantic observations, a set of predictions comprising one or more of: predicted occupancy at one or more spatial granularities, predicted heating or cooling gradients based on environmental conditions, thermal properties, and occupancy data, or predicted energy consumption patterns. The method further includes determining, by one or more energy optimization applications/services, optimal building control settings based on the set of predictions and external data comprising one or more of utility pricing data and weather data. The method also includes generating, by one or more virtual system controllers, vendor-neutral control commands based on the optimal building control settings. The method includes translating the vendor-neutral control commands into vendor-specific commands for the plurality of building management systems. Finally, the method includes transmitting, via the building API, the vendor-specific commands to the plurality of building management systems.

In various embodiments of the disclosure, a system for building energy and performance optimization is described. The system includes one or more processors and a memory storing instructions that, when executed by the one or more processors, cause the system to receive, via a building application programming interface (API), building data from a plurality of building management systems and sensor networks associated with a building. The instructions further cause the system to store the building data in a data lake. The instructions also cause the system to transform, by a data management middleware, the building data into semantic observations, the semantic observations comprising one or more of occupancy data, location data, and activity data. The instructions cause the system to generate, by one or more machine learning models trained on the semantic observations, a set of predictions comprising one or more of: predicted occupancy at one or more spatial granularities, predicted heating or cooling gradients based on environmental conditions, thermal properties, and occupancy data, or predicted energy consumption patterns. The instructions further cause the system to determine, by one or more energy optimization applications/services, optimal building control settings based on the set of predictions and external data comprising one or more of utility pricing data and weather data. The instructions cause the system to generate, by one or more virtual system controllers, vendor-neutral control commands based on the optimal building control settings. The instructions cause the system to translate the vendor-neutral control commands into vendor-specific commands for the plurality of building management systems. The instructions cause the system to transmit, via the building API, the vendor-specific commands to the plurality of building management systems.

In various embodiments of the disclosure, a non-transitory computer-readable storage medium with program instructions stored thereon is described. The program instructions when executed by one or more processors are operable to cause the one or more processors to perform operations comprising receiving, via a building application programming interface (API), building data from a plurality of building management systems and sensor networks associated with a building. The operations further comprise storing the building data in a data lake. The operations also comprise transforming, by a data management middleware, the building data into semantic observations, the semantic observations comprising one or more of occupancy data, location data, and activity data. The operations comprise generating, by one or more machine learning models trained on the semantic observations, a set of predictions comprising one or more of: predicted occupancy at one or more spatial granularities, predicted heating or cooling gradients based on environmental conditions, thermal properties, and occupancy data, or predicted energy consumption patterns. The operations further comprise determining, by one or more energy optimization applications/services, optimal building control settings based on the set of predictions and external data comprising one or more of utility pricing data and weather data. The operations comprise generating, by one or more virtual system controllers, vendor-neutral control commands based on the optimal building control settings. The operations comprise translating the vendor-neutral control commands into vendor-specific commands for the plurality of building management systems. The operations comprise transmitting, via the building API, the vendor-specific commands to the plurality of building management systems.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a block diagram that illustrates a network environment for building energy and performance optimization, in accordance with an embodiment of the disclosure;

FIG. 2 is a flowchart depicting a method for building energy and performance optimization with real-time control, in accordance with an embodiment of the disclosure;

FIG. 3 is a scenario diagram showing time-of-use optimization with solar and distributed energy resource integration, in accordance with an embodiment of the disclosure;

FIG. 4 is a flowchart depicting a continuous monitoring and adaptation process for building control settings, in accordance with an embodiment of the disclosure;

FIG. 5 is a flowchart depicting a preconditioning process based on predicted occupancy, in accordance with an embodiment of the disclosure;

FIG. 6 is a diagram that illustrates a spatial visualization interface for building energy and performance optimization, in accordance with an embodiment of the disclosure; and

FIG. 7 is a block diagram that illustrates a system for building energy and performance optimization, in accordance with an embodiment of the disclosure.

### DETAILED DESCRIPTION

Commercial buildings consume a substantial portion of global energy across subsystems including heating, ventilation, and air conditioning (HVAC), lighting, water heating, and refrigeration. Building management systems have been developed to monitor and control building subsystems, yet buildings often contain equipment from multiple vendors, each with proprietary interfaces and communication protocols. Data in such enterprise-scale systems, whether they be HVAC, security, or Wi-Fi infrastructures, may be siloed and/or ephemeral. Data generated by one building subsystem is rarely collected or used by another subsystem and is often not stored to provide deeper insights that may be possible by integrating and correlating such data. Building occupancy and usage patterns may vary over time, and external factors such as weather conditions and utility pricing may affect operating strategies. Buildings may have diverse orientations, physical characteristics, and usages, making it difficult to translate findings from one building to another.

Existing approaches to building energy management may face several challenges. Readily available building applications may be limited in their ability to access building information and perform real-time manipulation of in-building device and system configurations. Ad hoc or single-purpose sensor networks may be expensive to deploy and operate. Occupancy sensing may be important for energy savings, yet existing occupancy sensing technologies may rely on new hardware such as dedicated Wi-Fi equipment or active participation by end users through the download of applications for Bluetooth®-based solutions, which may limit use in commercial buildings. In-depth analyses may rely on building data collected at past intervals, and recommended actions may not be fed back to building systems in a timely manner, causing such analyses to become out-of-date. Generated insights may not be adjusted for the characteristics of a given facility. In some cases, organizations may create showcase smart buildings reconfigured with sensors and actuators and computing power equipped to perform complex analyses, yet such showcase buildings may not be scaled across campuses because they may be too expensive to activate and operate beyond their showcase context.

To address these challenges, the present disclosure describes a machine learning driven building energy optimization system with real-time control. The system may receive building data from a plurality of building management systems and sensor networks via a building application programming interface (API). The building data may be stored in a data lake. In some cases, the data lake may be implemented as an organizational data lake that creates a unified, integrated view of data captured across a plurality of systems, both within and across organizational boundaries. For instance, the data lake may change the paradigm of building data to support a hybrid transactional/analytical processing (HTAP) paradigm for building data.

A data management middleware may transform the building data into semantic observations comprising occupancy data, location data, and activity data. In some cases, the data management middleware may use passive inference from existing Wi-Fi network data for occupancy determination, converting Wi-Fi connectivity data into occupancy counts at a spatial granularity comprising one or more of room-level, region-level, and floor-level granularity. The data management middleware may be extensible to add new types of sensors, new types of semantic observations, and new machine learning and signal processing codes. The data management middleware may implement privacy by design, wherein data flows from sensors may be intercepted and subject to one or more privacy-preserving techniques comprising randomization, anonymization, scrubbing, policy-based access, encryption, or differential privacy.

One or more machine learning models trained on the semantic observations may generate predictions comprising predicted occupancy at one or more spatial granularities, predicted heating or cooling gradients based on environmental conditions, thermal properties, and occupancy data, or predicted energy consumption patterns. The one or more machine learning models may comprise deep learning architectures such as long short-term memory (LSTM) networks, convolutional neural networks (CNN), graph neural networks (GNN), or transformer architectures, as well as traditional machine learning models such as decision trees or gradient boosting. The one or more machine learning models may be trained using multimodal sensor data comprising sensor data, device data, camera data, motion sensor data, door open/close sensor data, and HVAC data. The predictions may be generated at one or more temporal granularities comprising hourly, daily, or weekly granularity. The one or more machine learning models may be incrementally updated as new data arrives using adaptive learning techniques.

One or more energy optimization applications/services may determine optimal building control settings based on the predictions and external data comprising utility pricing data and weather data. The one or more energy optimization applications/services may dynamically adapt as information changes and new information becomes available. In some cases, the one or more energy optimization applications/services may coordinate with distributed energy resources to implement time-of-use optimization, charging energy storage systems during off-peak and solar generation periods and discharging during peak pricing periods. One or more virtual system controllers may generate vendor-neutral control commands based on the optimal building control settings and translate the vendor-neutral control commands into vendor-specific commands for the plurality of building management systems. The vendor-specific commands may be transmitted via the building API to the plurality of building management systems.

The system described herein may provide several advantages. The system may enable real-time, closed-loop manipulation across heterogeneous building systems. The system may implement a closed-loop feedback mechanism that reconciles deviations between applied building states and optimal control settings. The system may provide unified data access across heterogeneous building systems without retrofitting single-purpose sensor networks. The system may leverage existing building infrastructure via the building API and existing sensors for occupancy detection, requiring no retrofitting of buildings with new sensing technologies. The system may enable privacy-preserving occupancy inference using existing infrastructure such as Wi-Fi networks. The machine learning models may be self-tuning models that learn building-specific behavior based on characteristics of a building comprising location, orientation, physical characteristics, and usage patterns. In some cases, the system may automatically learn building configurations to improve accuracy. The system may support preconditioning capabilities that proactively condition spaces before occupants arrive based on predicted occupancy and heating or cooling gradients. The system may provide a spatial visualization interface that displays predictions and building data and receives user input to adjust optimal building control settings. In some cases, the system may generate behavioral incentives to encourage occupant alignment with optimal building control settings. The system may provide unified, vendor-agnostic read/write orchestration enabling rapid scaling across building portfolios. In some cases, the system may be deployed at small property portfolios comprising ten to fifty buildings or scaled to large university or corporate campuses comprising several hundred buildings. In some cases, the system may target owner-occupants of ten to fifty large commercial buildings such as universities and state or local governments who may directly benefit from energy cost savings.

In various embodiments of the disclosure, a computer-implemented method for building energy and performance optimization is described. The method includes receiving, via a building application programming interface (API), building data from a plurality of building management systems and sensor networks associated with a building. The method further includes storing the building data in a data lake. The method further includes transforming, by a data management middleware, the building data into semantic observations. The semantic observations comprise one or more of occupancy data, location data, and activity data. The method further includes generating, by one or more machine learning models trained on the semantic observations, a set of predictions comprising one or more of predicted occupancy at one or more spatial granularities, predicted heating or cooling gradients based on environmental conditions, thermal properties, and occupancy data, or predicted energy consumption patterns. The method further includes determining, by one or more energy optimization applications/services, optimal building control settings based on the set of predictions and external data comprising one or more of utility pricing data and weather data. The method further includes generating, by one or more virtual system controllers, vendor-neutral control commands based on the optimal building control settings. The method further includes translating the vendor-neutral control commands into vendor-specific commands for the plurality of building management systems. The method further includes transmitting, via the building API, the vendor-specific commands to the plurality of building management systems.

In various embodiments of the disclosure, the vendor-specific commands are transmitted to adjust control points, schedules, and setpoints of a plurality of subsystems of the building in real time.

In various embodiments of the disclosure, the building data comprises data from existing building networks comprising a Wi-Fi infrastructure. The transforming of the building data into semantic observations comprises receiving Wi-Fi connectivity data from the Wi-Fi infrastructure and converting the Wi-Fi connectivity data into occupancy counts at a spatial granularity comprising one or more of room-level, region-level, and floor-level granularity.

In various embodiments of the disclosure, the one or more machine learning models comprise one or more of a long short-term memory (LSTM) network, a convolutional neural network (CNN), a graph neural network (GNN), or a transformer architecture. The one or more machine learning models are self-tuning models that learn building-specific behavior based on characteristics of the building comprising one or more of location, orientation, physical characteristics, and usage patterns.

In various embodiments of the disclosure, the generating of the set of predictions comprises generating the predicted occupancy at the one or more spatial granularities comprising one or more of meeting-room level granularities, region level granularities, floor level granularities, or building level granularities. The generating of the set of predictions further comprises generating the predicted occupancy at one or more temporal granularities comprising one or more of hourly, daily, or weekly granularity.

In various embodiments of the disclosure, the generating of the set of predictions comprises determining time duration to heat or cool a region of the building to a target temperature. The determination of the time duration is based on heating, ventilation, and air conditioning (HVAC) data, the environmental conditions, and the occupancy data.

In various embodiments of the disclosure, the external data further comprises calendar data and schedule data associated with occupants of the building. The determining of the optimal building control settings comprises receiving an occupancy indication from a calendar application associated with an occupant of the building. The occupancy indication comprises one or more of a scheduled meeting location, an in-office indication, or an out-of-office indication. The determining of the optimal building control settings further comprises generating a control setting to adjust heating or cooling in a space associated with the occupant based on the occupancy indication.

In various embodiments of the disclosure, the utility pricing data comprises time-of-use pricing data. The determining of the optimal building control settings comprises identifying a peak pricing period and an off-peak pricing period based on the time-of-use pricing data. The determining of the optimal building control settings further comprises generating control settings to charge an energy storage system during the off-peak pricing period and discharge the energy storage system during the peak pricing period. The determining of the optimal building control settings further comprises receiving solar generation data from a solar panel system associated with the building. The determining of the optimal building control settings further comprises generating control settings, based on the solar generation data, to charge the energy storage system during periods of solar generation.

In various embodiments of the disclosure, the building API provides bidirectional communication with the plurality of building management systems. The bidirectional communication comprises a read operation to receive the building data from the plurality of building management systems and a write operation to transmit the vendor-specific commands to the plurality of building management systems.

In various embodiments of the disclosure, the building data is received from a plurality of building management systems that control one or more of a heating, ventilation, and air conditioning (HVAC) system, a lighting system, a water heating system, or a refrigeration system.

In various embodiments of the disclosure, the building data comprises multimodal sensor data comprising one or more of sensor data, device data, actuator data, camera data, motion sensor data, door open/close sensor data, and HVAC data. The method further includes receiving additional data from a plurality of management systems. The method further includes updating the one or more machine learning models based on the additional data.

In various embodiments of the disclosure, the transforming of the building data into the semantic observations comprises applying, by the data management middleware, one or more privacy-preserving techniques comprising one or more of randomization, anonymization, scrubbing, policy-based access, encryption, and differential privacy to the building data.

In various embodiments of the disclosure, the method further includes displaying, via a spatial visualization interface, the set of predictions and the building data. The method further includes receiving, via the spatial visualization interface, a user input to adjust the optimal building control settings.

In various embodiments of the disclosure, the method further includes receiving, via the building API, feedback data indicating an applied state of the plurality of building management systems after the transmitting of the vendor-specific commands. The method further includes comparing the applied state to the optimal building control settings. The method further includes reconciling deviations between the applied state and the optimal building control settings.

In various embodiments of the disclosure, the method further includes detecting an anomaly in the building data or the set of predictions. The method further includes reverting, in response to the detection of the anomaly, the optimal building control settings to a baseline policy.

In various embodiments of the disclosure, the method further includes generating one or more behavioral incentives based on the set of predictions. The one or more behavioral incentives comprise one or more of targeted notifications, goal tracking, gamification elements, or credits. The method further includes transmitting the one or more behavioral incentives to one or more devices associated with occupants of the building to encourage alignment with the optimal building control settings.

In various embodiments of the disclosure, the determining of the optimal building control settings comprises identifying, based on the predicted occupancy, a space predicted to be occupied at a future time. The determining of the optimal building control settings further comprises generating a preconditioning control setting to heat or cool the space prior to the future time based on the predicted heating or cooling gradients.

In various embodiments of the disclosure, the set of predictions further comprises a predicted state-of-charge of a distributed energy resource associated with the building. The determining of the optimal building control settings is further based on the predicted state-of-charge.

In various embodiments of the disclosure, a system for building energy and performance optimization is described. The system comprises one or more processors and a memory storing instructions that, when executed by the one or more processors, cause the system to receive, via a building application programming interface (API), building data from a plurality of building management systems and sensor networks associated with a building. The instructions further cause the system to store the building data in a data lake. The instructions further cause the system to transform, by a data management middleware, the building data into semantic observations. The semantic observations comprise one or more of occupancy data, location data, and activity data. The instructions further cause the system to generate, by one or more machine learning models trained on the semantic observations, a set of predictions comprising one or more of predicted occupancy at one or more spatial granularities, predicted heating or cooling gradients based on environmental conditions, thermal properties, and occupancy data, or predicted energy consumption patterns. The instructions further cause the system to determine, by one or more energy optimization applications/services, optimal building control settings based on the set of predictions and external data comprising one or more of utility pricing data and weather data. The instructions further cause the system to generate, by one or more virtual system controllers, vendor-neutral control commands based on the optimal building control settings. The instructions further cause the system to translate the vendor-neutral control commands into vendor-specific commands for the plurality of building management systems. The instructions further cause the system to transmit, via the building API, the vendor-specific commands to the plurality of building management systems.

In various embodiments of the disclosure, a non-transitory computer-readable storage medium with program instructions stored thereon is described. The program instructions when executed by one or more processors are operable to cause the one or more processors to perform operations comprising receiving, via a building application programming interface (API), building data from a plurality of building management systems and sensor networks associated with a building. The operations further comprise storing the building data in a data lake. The operations further comprise transforming, by a data management middleware, the building data into semantic observations. The semantic observations comprise one or more of occupancy data, location data, and activity data. The operations further comprise generating, by one or more machine learning models trained on the semantic observations, a set of predictions comprising one or more of predicted occupancy at one or more spatial granularities, predicted heating or cooling gradients based on environmental conditions, thermal properties, and occupancy data, or predicted energy consumption patterns. The operations further comprise determining, by one or more energy optimization applications/services, optimal building control settings based on the set of predictions and external data comprising one or more of utility pricing data and weather data. The operations further comprise generating, by one or more virtual system controllers, vendor-neutral control commands based on the optimal building control settings. The operations further comprise translating the vendor-neutral control commands into vendor-specific commands for the plurality of building management systems. The operations further comprise transmitting, via the building API, the vendor-specific commands to the plurality of building management systems.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

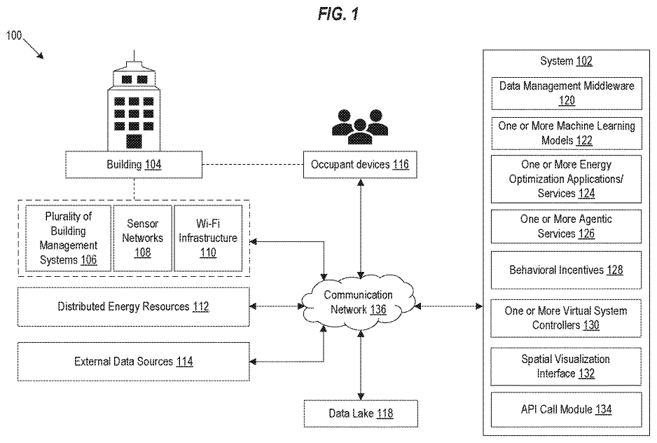

FIG. 1 is a block diagram that illustrates a network environment 100 for building energy and performance optimization, in accordance with an embodiment of the disclosure. With reference to FIG. 1, the network environment 100 includes a system 102, a building 104, external data sources 114, occupant devices 116, and a communication network 136. The system 102 includes a data lake 118, a data management middleware 120, one or more machine learning models 122, one or more energy optimization applications/services 124, one or more agentic services 126, behavioral incentives 128, one or more virtual system controllers 130, a spatial visualization interface 132, and an application programming interface (API) call module 134. The system 102 communicates with the building 104, the external data sources 114, and the occupant devices 116 via the communication network 136.

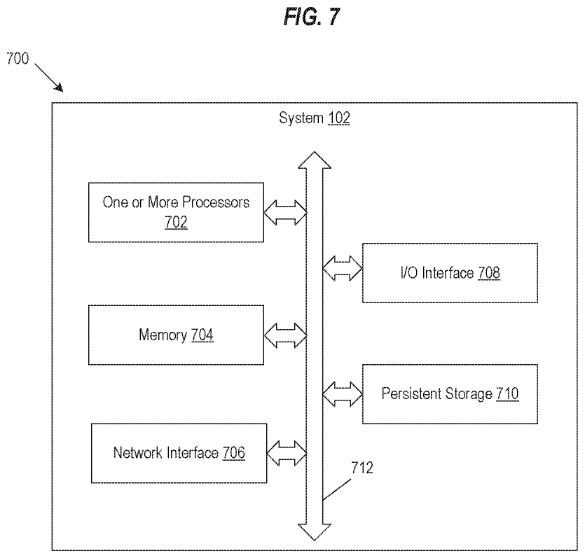

The system 102 is a computing system that performs the operations associated with building energy and performance optimization. The system 102 includes suitable logic, circuitry, and interfaces that receive building data from the plurality of building management systems 106 and sensor networks 108, apply the one or more machine learning models 122 to the building data, and generate vendor-specific commands based on determined optimal building control settings. In some embodiments, the system 102 is an exemplary embodiment of the system shown in FIG. 7, sharing architectural components such as the one or more processors 702, memory 704, and persistent storage 710 while implementing the data management middleware 120, the one or more machine learning models 122, and the one or more energy optimization applications/services 124 for real-time building control. The system 102 includes a processor set and one or more computer-readable storage media. Program instructions stored on the one or more computer-readable storage media cause the processor set to perform operations as described herein. The system 102 may be deployed in various configurations depending on the requirements of the building 104 or buildings being managed. In some cases, the system 102 may be implemented as a centralized computing platform, while in other cases, the system 102 may be implemented as a distributed computing system with components deployed across multiple locations. Examples of the system 102 may include, but are not limited to, a cloud-based computing platform, an on-premises server system, a distributed computing system, an edge computing system, a hybrid computing system combining cloud and on-premises resources, a dedicated server machine, a virtual machine instance hosted on cloud infrastructure, or a cluster of interconnected computing nodes.

Although FIG. 1 depicts certain components as being included within the system 102 and other components as being external to the system 102, the disclosure is not limited to this particular arrangement. The boundaries of the system 102 may be defined differently in various implementations. In some cases, the system 102 may include additional components not shown in FIG. 1, such as components associated with the building 104, the external data sources 114, or the occupant devices 116. In other cases, the system 102 may include fewer components than shown in FIG. 1, with certain components being implemented externally to the system 102 or omitted entirely. For example, the data lake 118 may be implemented as an external cloud-based storage service rather than as a component within the system 102. As another example, the spatial visualization interface 132 may be implemented on a separate computing device external to the system 102. As yet another example, the one or more machine learning models 122 may be hosted on a separate machine learning platform external to the system 102. Conversely, in some implementations, the system 102 may incorporate components shown as external in FIG. 1, such as incorporating the sensor networks 108 or the distributed energy resources 112 as integrated components of the system 102. The allocation of components between the system 102 and external entities may vary based on deployment requirements, computational resources, network architecture, and organizational preferences.

The building 104 may be any structure or facility that includes one or more building subsystems that may be monitored and controlled. The building 104 may include one or more floors, zones, rooms, or other spatial divisions. In some cases, the building 104 may be a single structure, while in other cases, the building 104 may represent a portion of a larger campus or facility. Examples of the building 104 may include, but are not limited to, a commercial office building, a university campus building, a government facility, a hospital, a retail facility, an industrial facility, or a multi-tenant building.

The building 104 includes a plurality of building management systems 106, sensor networks 108, a Wi-Fi infrastructure 110, and distributed energy resources 112. The plurality of building management systems 106 may control one or more of a heating, ventilation, and air conditioning (HVAC) system, a lighting system, a water heating system, or a refrigeration system. The plurality of building management systems 106 may include equipment from multiple vendors, each with proprietary interfaces and communication protocols. In some cases, the plurality of building management systems 106 may be implemented using a building management system (BMS) framework such as, for example, Honeywell's Niagara® BMS framework. Examples of the plurality of building management systems 106 may include, but are not limited to, HVAC controllers, lighting controllers, water heating controllers, refrigeration controllers, or other building subsystem controllers.

The sensor networks 108 may collect data from various sensors deployed throughout the building 104. The sensor networks 108 may include multimodal sensors such as cameras, passive infrared (PIR) sensors, motion sensors, badge readers, door open/close sensors, and carbon dioxide (CO₂) proxies for occupancy detection in addition to Wi-Fi-based inference. The sensor networks 108 may provide building data comprising multimodal sensor data comprising one or more of sensor data, device data, actuator data, camera data, motion sensor data, door open/close sensor data, and HVAC data. Examples of the sensor networks 108 may include, but are not limited to, temperature sensor networks, humidity sensor networks, occupancy sensor networks, air quality sensor networks, or energy metering networks.

The Wi-Fi infrastructure 110 may provide network connectivity within the building 104 and the system 102 may use the Wi-Fi infrastructure 110 for passive occupancy sensing. Wi-Fi® is a trademark of the Wi-Fi Alliance®. The Wi-Fi infrastructure 110 may include access points, routers, and controllers. In some cases, the system 102 may use the Wi-Fi infrastructure 110 for Wi-Fi infrastructure-based occupancy sensing using network data from existing Wi-Fi infrastructure coupled with machine learning to maintain dynamic and accurate occupancy counts at fine granularity comprising one or more of room-level, region-level, and floor-level granularity. The Wi-Fi infrastructure 110 may provide Wi-Fi connectivity data that the data management middleware 120 may convert into occupancy counts at a spatial granularity comprising one or more of room-level, region-level, and floor-level granularity. Examples of the Wi-Fi infrastructure 110 may include, but are not limited to, wireless access points, wireless routers, wireless controllers, or other wireless network equipment.

The distributed energy resources 112 may include battery energy storage systems, solar panel systems, or other energy generation and storage equipment. In some cases, the distributed energy resources 112 may include battery energy storage systems, solar photovoltaic (PV) inverters, electric vehicle supply equipment (EVSE), thermal storage, and controllable loads. In some cases, the distributed energy resources 112 may include solar panels and battery storage systems integrated via a custom-built driver to integrate equipment vendor application programming interfaces (APIs) with a BMS framework workbench. Examples of the distributed energy resources 112 may include, but are not limited to, battery energy storage systems, solar panel systems, solar PV inverters, electric vehicle charging stations, thermal storage systems, or controllable loads.

The external data sources 114 may provide external data comprising one or more of utility pricing data and weather data, as well as calendar data or other relevant information. The external data sources 114 may include environmental feeds such as weather data, irradiance data, and utility pricing data comprising utility tariff schedules including time-of-use pricing. In some cases, the external data sources 114 may provide tariff trajectory predictions or predicted utility pricing aligned with time-of-use or dynamic pricing schedules. The external data sources 114 may also include enterprise sources such as calendaring and scheduling data and organizational event data. In some cases, the external data sources 114 may provide occupant presence information derived from calendar applications, including scheduled meeting locations, in-office indications, and out-of-office indications. Examples of the external data sources 114 may include, but are not limited to, utility pricing services, weather services, irradiance data services, calendar services, scheduling services, or other data services.

The occupant devices 116 may be devices associated with occupants of the building 104. The system 102 may transmit behavioral incentives 128 to the occupant devices 116 to encourage alignment with optimal building control settings. Examples of the occupant devices 116 may include, but are not limited to, smartphones, tablets, laptop computers, desktop computers, wearable devices, or other computing devices.

The communication network 136 may facilitate data exchange and communication between the system 102, the building 104, the external data sources 114, and the occupant devices 116. The communication network 136 may be implemented as a wired or wireless network infrastructure that supports various communication protocols and connection types. Examples of the communication network 136 may include, but are not limited to, a local area network (LAN), a wide area network (WAN), the Internet, a wireless local area network (WLAN), a cellular network, a virtual private network (VPN), or a hybrid network combining multiple communication technologies and protocols.

Although the disclosure describes the network environment 100 with reference to a single building, the disclosure is not limited to a single building. In some cases, the system 102 may be configured to manage a plurality of buildings, a campus comprising multiple buildings, or a portfolio of buildings across multiple geographic locations. The system 102 may receive building data from and transmit vendor-specific commands to the plurality of building management systems 106 and sensor networks 108 associated with any number of buildings.

Although the disclosure describes communication via a building application programming interface (API), the disclosure is not limited to a single building API. In some cases, the system 102 may use multiple building APIs, multiple communication protocols, or multiple integration methods to communicate with the plurality of building management systems 106, the sensor networks 108, the Wi-Fi infrastructure 110, and the distributed energy resources 112. The system 102 may support heterogeneous integration approaches to accommodate different vendor systems and communication standards.

The data lake 118 stores building data received from the plurality of building management systems 106, the sensor networks 108, the Wi-Fi infrastructure 110, and the distributed energy resources 112. As used herein, a data lake refers to a centralized repository that stores raw and processed data at any scale, enabling both operational queries and analytical pipelines. The data lake 118 may also store external data received from the external data sources 114, such as weather data, utility pricing data comprising time-of-use pricing, calendar data, and occupant count data. The data lake 118 may be implemented as an organizational data lake that creates a unified, integrated view of data captured across a plurality of systems, both within and across organizational boundaries. The data lake 118 may store raw streams, harmonized schemas, semantic observations, and model artifacts. The data lake 118 may support a hybrid transactional/analytical processing (HTAP) paradigm for building data. Examples of the data lake 118 may include, but are not limited to, a cloud-based data lake, an on-premises data lake, a distributed data storage system, or a hybrid data storage system.

The data management middleware 120 transforms the building data into semantic observations comprising one or more of occupancy data, location data, and activity data. As used herein, semantic observations refer to higher-level, meaningful representations of building state derived from raw sensor data, wherein the semantic observations abstract low-level signals into contextual information about the building environment and its occupants. As used herein, data management middleware refers to software that mediates between raw sensor data sources and higher-level applications, performing data transformation, integration, and privacy-preserving operations. In some cases, the data management middleware 120 may integrate data from parallel sensor networks and third-party systems to generate the semantic observations. The data management middleware 120 may be implemented as a scalable data management middleware for modeling smart spaces that implements privacy-by-design. In some cases, the data management middleware 120 may be implemented using a middleware platform such as, for example, TIPPERS® (The Internet of Things Platform for Smart Spaces). The data management middleware 120 may include a Wi-Fi infrastructure-based occupancy sensing module that uses network data from existing Wi-Fi infrastructure coupled with machine learning to maintain dynamic and accurate occupancy counts at fine granularity comprising one or more of room-level, region-level, and floor-level granularity. The data management middleware 120 may provide a data model that digitally represents the physical world including geography, concepts and entities, sensors, and dynamic observations. The data management middleware 120 may support a concept of virtualization that represents dynamic data at both the raw sensor level and at the semantic level in the form of a dynamically evolving state of the physical world. The data management middleware 120 may provide extensible interfaces to add new types of sensors, new types of semantic observations, and new machine learning and signal processing codes to translate between sensor and semantic levels. The data management middleware 120 may use passive inference from existing Wi-Fi network data for occupancy determination, converting Wi-Fi connectivity data into occupancy counts at a spatial granularity comprising one or more of room-level, region-level, and floor-level granularity. The data management middleware 120 may implement privacy by design, wherein the data management middleware 120 intercepts data flows from sensors and applies one or more privacy-preserving techniques comprising randomization, anonymization, scrubbing, aggregation, policy-based access, encryption, or differential privacy. Examples of the data management middleware 120 may include, but are not limited to, a smart-space middleware, a privacy-preserving middleware, a data transformation middleware, or a semantic observation middleware.

The one or more machine learning models 122 are trained on the semantic observations to generate a set of predictions comprising one or more of: predicted occupancy at one or more spatial granularities, predicted heating or cooling gradients based on environmental conditions, thermal properties, and occupancy data, or predicted energy consumption patterns. In some cases, the one or more machine learning models 122 may generate site load forecasts that consider internal gains, distributed energy resource contributions, and operational schedules. In some cases, the one or more machine learning models 122 may generate distributed energy resource availability forecasts in addition to state-of-charge predictions. In some cases, the one or more machine learning models 122 may be implemented as prediction services that provide occupancy predictions, heating and cooling load predictions, and schedule and activity predictions. The one or more machine learning models 122 may comprise deep learning architectures such as long short-term memory (LSTM) networks, convolutional neural networks (CNN), graph neural networks (GNN), or transformer architectures, as well as traditional machine learning models such as XGBoost, decision trees, or gradient boosting. The one or more machine learning models 122 may be trained using multimodal sensor data comprising sensor data, device data, camera data, motion sensor data, door open/close sensor data, and HVAC data. The one or more machine learning models 122 may generate the set of predictions at one or more temporal granularities comprising hourly, daily, or weekly granularity. The one or more machine learning models 122 may be incrementally updated as new data arrives using adaptive learning techniques. The one or more machine learning models 122 may be self-tuning models that learn building-specific behavior based on characteristics of the building 104 comprising one or more of location, orientation, physical characteristics, and usage patterns. Examples of the one or more machine learning models 122 may include, but are not limited to, occupancy prediction models, heating gradient prediction models, cooling gradient prediction models, energy consumption prediction models, site load forecasting models, or distributed energy resource availability models.

The one or more energy optimization applications/services 124 determine optimal building control settings based on the set of predictions and external data comprising one or more of utility pricing data and weather data. As used herein, optimal building control settings refer to configuration parameters for building subsystems that are determined to achieve desired objectives such as energy efficiency, cost reduction, demand peak reduction, or occupant comfort based on the set of predictions and external data. The one or more energy optimization applications/services 124 may exploit predictive models of occupancy and building heating and cooling behavior, coupled with utility pricing data comprising time-of-use pricing, as well as external data such as predicted weather information and schedule of activity associated with the building 104. In some cases, the one or more energy optimization applications/services 124 may implement artificial intelligence (AI)-driven energy scheduling to optimize building usage. In some cases, the one or more energy optimization applications/services 124 may implement occupancy-based heating and cooling to adjust temperature setpoints based on predicted or detected occupancy. In some cases, the one or more energy optimization applications/services 124 may generate distributed energy resource charge and discharge schedules to minimize energy cost and demand peaks subject to equipment constraints, reserve constraints, and comfort constraints. In some cases, the one or more energy optimization applications/services 124 may generate lighting and ventilation policies coordinated with occupancy and indoor air quality targets. The one or more energy optimization applications/services 124 may dynamically adapt as information changes and new information becomes available. In some cases, the one or more energy optimization applications/services 124 may operate in conjunction with the one or more agentic services 126 to provide autonomous, agent-assisted, or operator-prompted optimization. Examples of the one or more energy optimization applications/services 124 may include, but are not limited to, HVAC optimization applications/services, lighting optimization applications/services, ventilation optimization applications/services, energy storage optimization applications/services, demand response applications, or load scheduling applications.

The one or more agentic services 126 may operate autonomously or with operator prompts. The one or more agentic services 126 may provide applications that operate in autonomous, agent-assisted, or operator-in-the-loop modes. The one or more agentic services 126 may generate and display alerts, dashboards, and reports. Examples of the one or more agentic services 126 may include, but are not limited to, autonomous control services, agent-assisted control services, operator-in-the-loop control services, or policy enforcement services.

The system 102 generates behavioral incentives 128 to encourage alignment with optimal building control settings. The behavioral incentives 128 may comprise one or more of targeted notifications, goal tracking, gamification elements, or credits. The system 102 transmits the behavioral incentives 128 to the occupant devices 116 to encourage alignment with recommended actions. Examples of the behavioral incentives 128 may include, but are not limited to, energy savings notifications, goal tracking dashboards, gamification rewards, energy credits, or behavioral nudges.

The one or more virtual system controllers 130 generate vendor-neutral control commands based on the optimal building control settings and translate the vendor-neutral control commands into vendor-specific commands for the plurality of building management systems 106. The one or more virtual system controllers 130 may be logical control entities that synthesize vendor-neutral schedules and setpoints. As used herein, vendor-neutral control commands refer to control instructions expressed in a standardized, protocol-independent format that specify desired building system behaviors without reference to any particular vendor's proprietary interface or command syntax. The one or more virtual system controllers 130 translate the vendor-neutral control commands into vendor-specific commands, wherein vendor-specific commands refer to control instructions formatted according to the proprietary protocols, command structures, and interface requirements of particular building management system vendors. The API call module 134 transmits the vendor-specific commands to adjust control points, schedules, and setpoints of a plurality of subsystems of the building 104 in real time. Examples of the one or more virtual system controllers 130 may include, but are not limited to, HVAC virtual controllers, lighting virtual controllers, energy storage virtual controllers, or multi-system virtual controllers.

The spatial visualization interface 132 displays the set of predictions and building data and receives user input to adjust optimal building control settings. The spatial visualization interface 132 may be implemented using a digital twin visualization platform to locate alerts, view performance, and manipulate physical buildings based on insights and recommendations. The spatial visualization interface 132 may provide dashboard integration with spatial viewers. In some embodiments, the spatial visualization interface 132 may include a floor plan view that displays a plurality of zones representing different rooms or areas within the building 104, wherein each zone may show occupancy information including the number of occupants and an occupancy level indicator. In some cases, the spatial visualization interface 132 may include a predictions display that presents predicted occupancy data, heating gradient information indicating time to reach a target temperature, energy forecast data showing predicted energy consumption, and HVAC state information including setpoint and mode settings. The spatial visualization interface 132 may include one or more setpoint controls that allow a user to adjust optimal building control settings by selecting a temperature value along a range, and may include an apply button to enable the user to confirm and apply the adjusted settings to the plurality of building management systems 106. Examples of the spatial visualization interface 132 may include, but are not limited to, a three-dimensional (3D) digital twin viewer, a floor plan viewer, a building performance dashboard, or a spatial analytics interface.

In some embodiments, the spatial visualization interface 132 may support a variety of visualization modes and display configurations. In some cases, the spatial visualization interface 132 may include a multi-building occupancy display that presents occupancy levels across multiple floors of multiple buildings simultaneously, wherein each floor may display a color-coded occupancy indicator such as High, Medium, or Low to provide an intuitive visual representation of current space utilization patterns. In some embodiments, the spatial visualization interface 132 may include an individual space-level monitoring view that displays occupancy data for a specific room or space, including a time-series graph tracking occupancy patterns over a defined period, a circular gauge or donut chart displaying a current occupancy percentage representing the percentage of total room capacity currently in use, and tabular data showing groups who visited the room along with their corresponding number of visits. In some cases, the spatial visualization interface 132 may include a region-level spatial analytics view that enables detailed occupancy monitoring and trend analysis across different regions of the building 104, including a time-series graph showing occupancy trends over a selected date range with multiple overlapping colored lines representing different data series or time periods. In some embodiments, the spatial visualization interface 132 may include a three-dimensional digital twin viewer that displays building devices including thermostats and distributed energy resources 112 such as battery storage systems and solar installations within a spatial context, wherein accessed device data may be shown both in an application pane and in an embedded spatial viewer. In some cases, the spatial visualization interface 132 may include a calendar integration interface that displays a workflow from calendar status to HVAC updates, wherein spatial controls may be linked to an occupant's calendar application such that an out-of-office indication may trigger adjustment of room controls. In some embodiments, the spatial visualization interface 132 may include a time-of-use pricing dashboard that displays battery state-of-charge graphs aligned with utility pricing data comprising utility pricing schedules, including annotations indicating charging during periods of cheapest electricity rates and discharging during periods of most expensive electricity to avoid drawing power from the grid, along with a color-coded time-of-use pricing bar indicating multiple rate tiers such as daytime, evening peak, and overnight pricing. In some cases, the spatial visualization interface 132 may include an executive reporting interface that displays energy performance analytics and dashboards containing line graphs and data visualizations that track energy performance metrics aligned with utility pricing data comprising time-of-use pricing schedules.

In some embodiments, the spatial visualization interface 132 may support a variety of user input mechanisms for interacting with building data and control settings. In some cases, the spatial visualization interface 132 may include a hierarchical navigation panel displaying a list of selectable building locations and organizational units, wherein users may select specific buildings, floors, regions, or rooms from an expandable tree structure to view corresponding occupancy data or other building information. In some embodiments, the spatial visualization interface 132 may include date range selectors for historical analysis, allowing users to select custom date ranges for viewing time-series data and generating reports. In some cases, the spatial visualization interface 132 may include location selection interfaces with expandable tree structures listing various departments, research groups, facilities, and other organizational spaces. In some embodiments, the spatial visualization interface 132 may include controls for adjusting temperature setpoints, wherein a user may select a temperature value along a displayed range and confirm the selection via an apply button to transmit the adjusted settings to the plurality of building management systems 106. In some cases, the spatial visualization interface 132 may integrate with calendar applications to receive occupancy indications, wherein a user may log into a calendar application, set an out-of-office status, and the system 102 may automatically update HVAC or digital twin settings based on the calendar status. In some embodiments, the spatial visualization interface 132 may include report generation and saving functions, allowing users to generate and save reports based on displayed energy performance data and utility pricing data comprising time-of-use pricing information. In some cases, the spatial visualization interface 132 may include navigation icons and controls for accessing different system functions, filter options for selecting different locations and time ranges, and search functionality for locating specific projects or data points within the interface.

The API call module 134 facilitates bidirectional communication with the plurality of building management systems 106, the sensor networks 108, the Wi-Fi infrastructure 110, and the distributed energy resources 112 via the communication network 136. The API call module 134 enables both read operations to receive building data and write operations to transmit vendor-specific commands. The API call module 134 implements a building application programming interface (API), wherein the building API provides bidirectional communication with the plurality of building management systems 106. As used herein, a building API refers to a vendor-agnostic integration layer that exposes normalized read/write access to heterogeneous building subsystems and distributed energy resources through a unified interface. The building API may communicate using protocols including, for example, BACnet®, Modbus®, vendor representational state transfer (REST)/Google remote procedure call (gRPC), message queuing telemetry transport (MQTT), or open platform communications unified architecture (OPC UA), abstracted behind a unified API. The building API may access and manipulate devices outside traditional building management systems including BACnet® devices and battery storage and solar installations through newly created drivers. In some cases, the building API may be implemented using a BMS framework that provides normalized read/write access to heterogeneous building subsystems and distributed energy resources. In some cases, the building API may be implemented using an integrated API platform such as, for example, GeoBMS®. Examples of the API call module 134 may include, but are not limited to, a BACnet® API module, a Modbus® API module, a REST API module, a gRPC API module, an MQTT API module, an OPC UA API module, or a unified building API module.

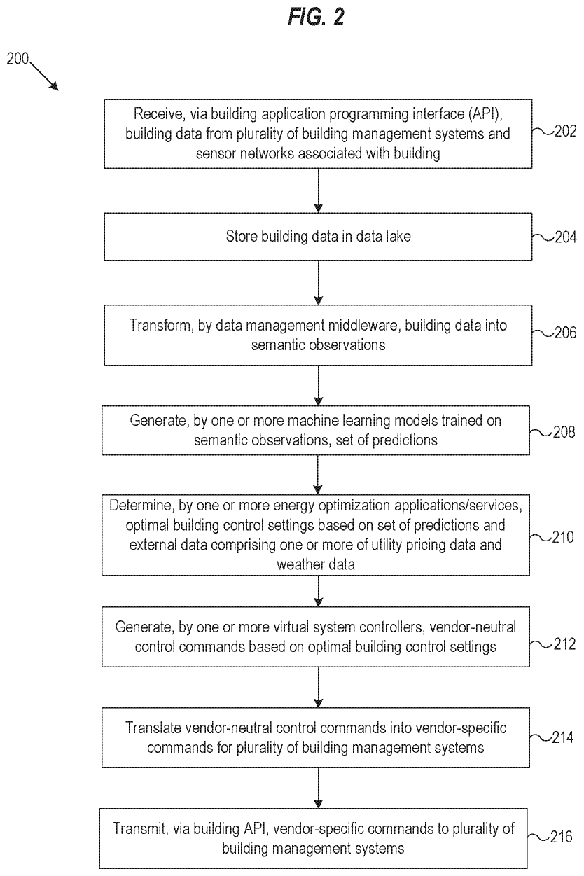

The operations of the system 102 are described further with reference to FIGS. 2-6.

FIG. 2 is a flowchart depicting a method for building energy and performance optimization with real-time control, in accordance with an embodiment of the disclosure. FIG. 2 is explained in conjunction with elements from FIG. 1. With reference to FIG. 2, there is shown a flowchart 200. The operations of the flowchart 200 may be executed by any computing system, for example, by the system 102 of FIG. 1. The flowchart 200 includes operations from 202 to 216. The operations of the flowchart 200 may start at 202.

At 202, the operations include receiving, via a building application programming interface (API), building data from a plurality of building management systems and sensor networks associated with a building. The building API provides bidirectional communication with the plurality of building management systems 106, and the bidirectional communication comprises a read operation to receive the building data from the plurality of building management systems 106 and a write operation to transmit vendor-specific commands to the plurality of building management systems 106. The building data may be received from the plurality of building management systems 106, the sensor networks 108, the Wi-Fi infrastructure 110, and the distributed energy resources 112 via the API call module 134. For example, the building data may include temperature readings from HVAC controllers, lighting schedules from lighting controllers, water heater setpoints from water heating systems, and refrigeration compressor states from refrigeration controllers. The building data may comprise data from existing building networks comprising the Wi-Fi infrastructure 110. The building data may comprise multimodal sensor data comprising one or more of sensor data, device data, actuator data, camera data, motion sensor data, door open/close sensor data, and HVAC data. For example, the multimodal sensor data may include a camera detecting room occupancy in a conference room, a motion sensor detecting presence in a hallway, a door sensor indicating entry into a meeting space, and a CO2 sensor providing an occupancy proxy for a lecture hall. In some cases, the building API may communicate using protocols including, for example, BACnet®, Modbus®, vendor representational state transfer (REST)/Google remote procedure call (gRPC), message queuing telemetry transport (MQTT), or open platform communications unified architecture (OPC UA), abstracted behind a unified API. In some cases, the building API may access and manipulate devices outside traditional building management systems including BACnet® devices and battery storage and solar installations through newly created drivers.

At 204, the operations include storing the building data in a data lake. The data lake 118 may store the building data received from the plurality of building management systems 106, the sensor networks 108, the Wi-Fi infrastructure 110, and the distributed energy resources 112. For example, the data lake 118 may store raw temperature sensor readings from HVAC zones alongside utility tariff schedules indicating time-of-use pricing periods and weather forecasts predicting outdoor temperatures for the next 24 hours. The data lake 118 may also store external data received from the external data sources 114, such as weather data, utility pricing data comprising time-of-use pricing, and calendar data. In some cases, the data lake 118 may be implemented as an organizational data lake that creates a unified, integrated view of data captured across a plurality of systems, both within and across organizational boundaries. In some cases, the data lake 118 may store raw streams, harmonized schemas, semantic observations, and model artifacts. In some cases, the data lake 118 may support a hybrid transactional/analytical processing (HTAP) paradigm for building data. In some cases, the system 102 may be deployed in a centralized embodiment where all services operate on a cloud platform with secure tunnels to on-premises building management systems and distributed energy resources. In some cases, the system 102 may be deployed in an on-premises embodiment where all services operate on a site server hosted within facilities' networks. In some cases, the system 102 may be deployed in a hybrid embodiment where ingestion, actuation, and privacy layers run on-premises while model training and heavy analytics run in the cloud.

At 206, the operations include transforming, by a data management middleware, the building data into semantic observations. The semantic observations comprise one or more of occupancy data, location data, and activity data. The data management middleware 120 transforms the building data into the semantic observations. In some cases, the data management middleware 120 may provide a data model that digitally represents the physical world including geography, concepts and entities, sensors, and dynamic observations. In some cases, the data management middleware 120 may support a concept of virtualization that represents dynamic data at both the raw sensor level and at the semantic level in the form of a dynamically evolving state of the physical world. In some cases, the data management middleware 120 may provide extensible interfaces to add new types of sensors, new types of semantic observations, and new machine learning and signal processing codes to translate between sensor and semantic levels. In some cases, the data management middleware 120 may include a Wi-Fi infrastructure-based occupancy sensing module that uses network data from existing Wi-Fi infrastructure coupled with machine learning to maintain dynamic and accurate occupancy counts at fine granularity. In some cases, the transforming of the building data into semantic observations comprises receiving Wi-Fi connectivity data from the Wi-Fi infrastructure 110 and converting the Wi-Fi connectivity data into occupancy counts at a spatial granularity comprising one or more of room-level, region-level, floor-level, and building-level granularity. For example, the data management middleware 120 may receive Wi-Fi connectivity data indicating that 15 devices are connected to access points in a conference room region and convert this data into an occupancy count of approximately 12 occupants based on learned device-to-occupant ratios for that space. The data management middleware 120 may be self-adaptive and may automatically learn building configurations using advanced machine learning to improve occupancy counts without requiring retrofitting of buildings with new sensing technologies. In some cases, the sensor networks 108 may include multimodal sensors such as cameras, passive infrared (PIR) sensors, motion sensors, badge readers, door open/close sensors, and carbon dioxide (CO2) proxies for occupancy detection in addition to Wi-Fi-based inference. In some cases, the transforming of the building data into the semantic observations comprises applying, by the data management middleware 120, one or more privacy-preserving techniques comprising one or more of randomization, anonymization, scrubbing, aggregation, policy-based access, encryption, and differential privacy to the building data. For example, the data management middleware 120 may apply differential privacy to occupancy counts before storage, adding calibrated noise to protect individual presence information while preserving aggregate occupancy trends, or may anonymize device identifiers by replacing MAC addresses with non-reversible tokens. The data management middleware 120 may apply privacy mechanisms with configurable budgets per data source, space, or user role.

At 208, the operations include generating, by one or more machine learning models trained on the semantic observations, a set of predictions. The set of predictions comprises one or more of: predicted occupancy at one or more spatial granularities, predicted heating or cooling gradients based on environmental conditions, thermal properties, and occupancy data, or predicted energy consumption patterns. The one or more machine learning models 122 may comprise one or more of a long short-term memory (LSTM) network, a convolutional neural network (CNN), a graph neural network (GNN), or a transformer architecture, as well as traditional machine learning models such as decision trees or gradient boosting. For example, the one or more machine learning models 122 may predict that a conference room will be occupied by 8 people at 2:00 PM based on calendar data indicating a scheduled meeting and historical occupancy patterns for that room on similar days. As another example, the one or more machine learning models 122 may predict that heating a particular zone from 65 °F to 72 °F will require 45 minutes based on the thermal properties of the zone, the current outdoor temperature of 40 °F, and the expected occupancy heat load. The one or more machine learning models 122 may be self-tuning models that learn building-specific behavior based on characteristics of the building 104 comprising one or more of location, orientation, physical characteristics, and usage patterns. In some cases, the one or more machine learning models 122 may automatically learn building configurations to improve accuracy. The one or more machine learning models 122 may generate the set of predictions at one or more temporal granularities comprising hourly, daily, or weekly granularity. In some cases, the one or more machine learning models 122 may generate the set of predictions in the form of a calendar that presents predicted values of occupancy and heating or cooling gradients at different spatial and temporal granularities. The one or more machine learning models 122 may be incrementally updated using adaptive learning techniques as new data arrives to refine predictions. In some cases, the method further comprises receiving additional data from a plurality of management systems and updating the one or more machine learning models 122 based on the additional data.

At 210, the operations include determining, by one or more energy optimization applications/services, optimal building control settings based on the set of predictions and external data. The external data comprises one or more of utility pricing data and weather data. The optimal building control settings may comprise one or more of schedules, setpoints, and dispatch commands for building subsystems. The one or more energy optimization applications/services 124 may exploit predictive models of occupancy and building heating and cooling behavior, coupled with utility pricing data comprising time-of-use pricing, as well as external data such as predicted weather information and schedule of activity associated with the building 104. For example, the one or more energy optimization applications/services 124 may determine that a conference room should begin preconditioning at 1:15 PM to reach a target temperature of 72 °F by a 2:00 PM meeting start time, based on the predicted heating gradient of 45 minutes for that zone. As another example, the one or more energy optimization applications/services 124 may determine that lighting in an unoccupied zone should dim to 50% to reduce energy consumption while maintaining baseline illumination for safety. In some cases, the one or more energy optimization applications/services 124 may implement artificial intelligence (AI)-driven energy scheduling to optimize building usage. In some cases, the one or more energy optimization applications/services 124 may implement occupancy-based heating and cooling to adjust temperature setpoints based on predicted or detected occupancy. In some cases, the one or more energy optimization applications/services 124 may generate ventilation policies coordinated with indoor air quality targets. In some cases, the one or more energy optimization applications/services 124 may generate lighting and ventilation policies coordinated with occupancy and air quality targets. The one or more energy optimization applications/services 124 may dynamically adapt as information changes and new information becomes available. In some cases, the one or more energy optimization applications/services 124 may detect an anomaly in the building data or the set of predictions, such as a sensor malfunction reporting implausible temperature values or an unexpected occupancy pattern deviating significantly from predictions, and in response to the detection of the anomaly, the one or more energy optimization applications/services 124 may revert the optimal building control settings to a baseline policy to maintain safe and comfortable building conditions. The one or more energy optimization applications/services 124 may operate in autonomous mode, agent-assisted mode, or operator-in-the-loop mode with policy approvals. In some cases, the one or more energy optimization applications/services 124 may operate in conjunction with the one or more agentic services 126 to provide autonomous, agent-assisted, or operator-prompted optimization. In some cases, the external data sources 114 may provide occupant presence information derived from calendar applications, including scheduled meeting locations, in-office indications, and out-of-office indications.

At 212, the operations include generating, by one or more virtual system controllers, vendor-neutral control commands based on the optimal building control settings. The one or more virtual system controllers 130 generate the vendor-neutral control commands, wherein the vendor-neutral control commands are control instructions expressed in a standardized, protocol-independent format that specify desired building system behaviors without reference to any particular vendor's proprietary interface or command syntax. For example, a vendor-neutral control command may specify “set zone temperature to 72 °F” for a particular HVAC zone or “reduce lighting to 50%” for an unoccupied area, without specifying the protocol or command syntax required by any particular vendor's equipment. In some cases, the one or more virtual system controllers 130 may be logical control entities that synthesize vendor-neutral schedules and setpoints.

At 214, the operations include translating the vendor-neutral control commands into vendor-specific commands for the plurality of building management systems. The one or more virtual system controllers 130 translate the vendor-neutral control commands into the vendor-specific commands, wherein the vendor-specific commands are control instructions formatted according to the proprietary protocols, command structures, and interface requirements of particular building management system vendors. For example, a vendor-neutral command specifying “set zone temperature to 72 °F” may be translated into a BACnet® write command targeting a specific object identifier and property for one HVAC controller, while the same vendor-neutral command may be translated into a Modbus® register write to a different address for another HVAC controller from a different vendor. In some cases, the translation may accommodate equipment from multiple vendors, each with proprietary interfaces and communication protocols.

At 216, the operations include transmitting, via the building API, the vendor-specific commands to the plurality of building management systems. The API call module 134 transmits the vendor-specific commands to the plurality of building management systems 106 via the communication network 136. The vendor-specific commands may be transmitted to adjust control points, schedules, and setpoints of a plurality of subsystems of the building 104 in real time. For example, the API call module 134 may transmit a command to adjust an HVAC setpoint from 68 °F to 72 °F in anticipation of predicted occupancy, or may transmit a command to dim lighting to 30% in a zone that has been unoccupied for a threshold period. In some cases, the plurality of building management systems 106 may control one or more of a heating, ventilation, and air conditioning (HVAC) system, a lighting system, a water heating system, or a refrigeration system. In some cases, the vendor-specific commands may be transmitted to the distributed energy resources 112 comprising battery energy storage systems, solar photovoltaic (PV) inverters, electric vehicle supply equipment (EVSE), thermal storage, and controllable loads. In some cases, the method may further comprise generating, by the system 102, behavioral incentives 128 based on the set of predictions, the behavioral incentives 128 comprising one or more of targeted notifications, goal tracking, gamification elements, or credits, and transmitting the behavioral incentives 128 to the occupant devices 116 to encourage alignment with the optimal building control settings. For example, the system 102 may transmit a notification to the occupant devices 116 encouraging an occupant to close window blinds during peak cooling hours to reduce HVAC load, or may provide energy credits to occupants who adjust personal thermostat preferences to align with building-wide optimization goals. In some cases, the spatial visualization interface 132 may display the set of predictions and the building data, and may receive user input to adjust the optimal building control settings prior to the generating of the vendor-neutral control commands.

The flowchart 200 depicts a sequence of operations that enables data-driven building energy optimization through the collection of building data, transformation into semantic observations, generation of predictions using machine learning models, determination of optimal control settings, and real-time transmission of control commands to building management systems via a vendor-agnostic interface. The bidirectional communication capabilities of the building API enable closed-loop real-time control, wherein the system 102 may receive building data via read operations and transmit vendor-specific commands via write operations to implement the optimal building control settings determined by the one or more energy optimization applications/services 124. In some cases, the set of predictions may be presented in the form of a calendar that displays predicted occupancy and heating or cooling gradients at different spatial and temporal granularities, enabling operators to visualize anticipated building conditions over time. In some cases, the system 102 may provide unified, vendor-agnostic read/write orchestration enabling rapid scaling across building portfolios. In some cases, the system 102 may be deployed at a university campus level or scaled to a size of one million large commercial buildings. In some cases, the system 102 may target owner-occupants of ten to fifty large commercial buildings such as universities and state or local governments who may directly benefit from energy cost savings.

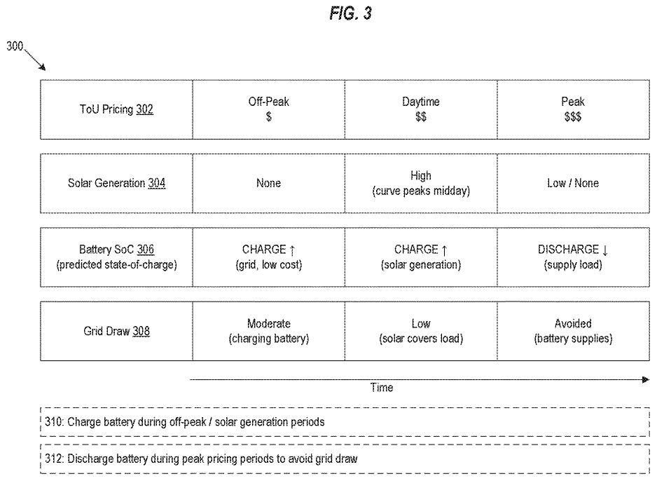

FIG. 3 is a scenario diagram showing time-of-use optimization with solar and distributed energy resource integration, in accordance with an embodiment of the disclosure. FIG. 3 is explained in conjunction with elements from FIG. 1 and FIG. 2. With reference to FIG. 3, there is shown a scenario 300. The scenario 300 illustrates coordination between utility pricing data, solar generation data, and battery state-of-charge predictions across off-peak, daytime, and peak pricing periods.

The scenario 300 includes time-of-use pricing 302, solar generation 304, a battery state-of-charge 306, a grid draw 308, a charge instruction 310, and a discharge instruction 312. The time-of-use pricing 302 represents utility pricing data comprising utility tariff schedules that define different rate tiers across time periods. In the scenario 300, the time-of-use pricing 302 is shown across three tiers corresponding to off-peak pricing, daytime pricing, and peak pricing periods. The solar generation 304 represents solar generation data received from a solar panel system associated with the building 104. The battery state-of-charge 306 represents a predicted state-of-charge of a distributed energy resource associated with the building 104. The grid draw 308 represents the amount of power drawn from the utility grid during each pricing period. The charge instruction 310 represents a control setting to charge an energy storage system, and the discharge instruction 312 represents a control setting to discharge the energy storage system.

In the scenario 300, the one or more energy optimization applications/services 124 identify a peak pricing period and an off-peak pricing period based on the time-of-use pricing data. The one or more energy optimization applications/services 124 generate control settings to charge the energy storage system during the off-peak pricing period and discharge the energy storage system during the peak pricing period. The one or more energy optimization applications/services 124 receive solar generation data from the solar panel system associated with the building 104 and generate control settings, based on the solar generation data, to charge the energy storage system during periods of solar generation.

During off-peak periods, the solar generation 304 may be none or low, and the charge instruction 310 directs the energy storage system to charge using low-cost grid power. The battery state-of-charge 306 increases during off-peak periods as the energy storage system accumulates energy at lower utility rates. The grid draw 308 may be moderate during off-peak charging periods.

During daytime periods, the solar generation 304 may be high with a midday peak. The charge instruction 310 directs the energy storage system to charge using solar generation. The battery state-of-charge 306 continues to increase as the energy storage system accumulates energy from the solar panel system. The grid draw 308 may be low during daytime periods when solar generation covers building load.

During peak pricing periods, the solar generation 304 may be low or none. The discharge instruction 312 directs the energy storage system to discharge to supply building load. The battery state-of-charge 306 decreases as the energy storage system provides power to the building 104. The grid draw 308 may be avoided or minimized during peak pricing periods because the battery supplies the load.

The one or more energy optimization applications/services 124 use the predicted state-of-charge and the time-of-use pricing data to generate control settings that charge the energy storage system during off-peak and solar generation periods and discharge the energy storage system during peak pricing periods. In some cases, the one or more energy optimization applications/services 124 may generate discharge schedules subject to reserve constraints that maintain a minimum state-of-charge for backup power or demand response participation. In some cases, the determining of the optimal building control settings is further based on the predicted state-of-charge of the distributed energy resource associated with the building 104. In some cases, the system 102 may apply heuristic optimization to achieve energy cost savings by aligning storage with solar generation, consumption, and utility time-of-use pricing by manipulating storage levels to be full prior to the start of peak pricing.

As described above with reference to FIG. 2, the one or more machine learning models 122 may generate the set of predictions comprising predicted occupancy at one or more spatial granularities and at one or more temporal granularities. The generating of the set of predictions may comprise generating the predicted occupancy at the one or more spatial granularities comprising one or more of meeting-room level granularities, region level granularities, floor level granularities, or building level granularities. The generating of the set of predictions may further comprise generating the predicted occupancy at one or more temporal granularities comprising one or more of hourly, daily, or weekly granularity. In some cases, the one or more machine learning models 122 may generate predicted values of occupancy and heating or cooling gradients at different spatial and temporal granularities in the form of a calendar for scheduling purposes.

The generating of the set of predictions may comprise determining time duration to heat or cool a region of the building 104 to a target temperature. The determination of the time duration may be based on heating, ventilation, and air conditioning (HVAC) data, the environmental conditions, and the occupancy data. In some cases, the one or more machine learning models 122 may generate predictions for heating and cooling gradients that determine the time duration to heat or cool the building 104 based on past HVAC data, ambient environmental conditions, and occupancy data at different spatial and temporal granularities.

The one or more machine learning models 122 may include transformer architectures such as Spacetimeformer and Contiformer for prediction tasks. The one or more machine learning models 122 may include traditional machine learning models such as XGBoost and decision trees in addition to deep neural networks. The one or more machine learning models 122 may be trained using multimodal sensor data and may be incrementally updated as new data arrives using adaptive learning techniques.

The scenario 300 demonstrates coordination between the one or more energy optimization applications/services 124 and the distributed energy resources 112 to reduce energy costs by shifting energy consumption away from peak pricing periods. The one or more virtual system controllers 130 may generate vendor-neutral control commands based on the charge instruction 310 and the discharge instruction 312, and may translate the vendor-neutral control commands into vendor-specific commands for transmission to the distributed energy resources 112 via the API call module 134.

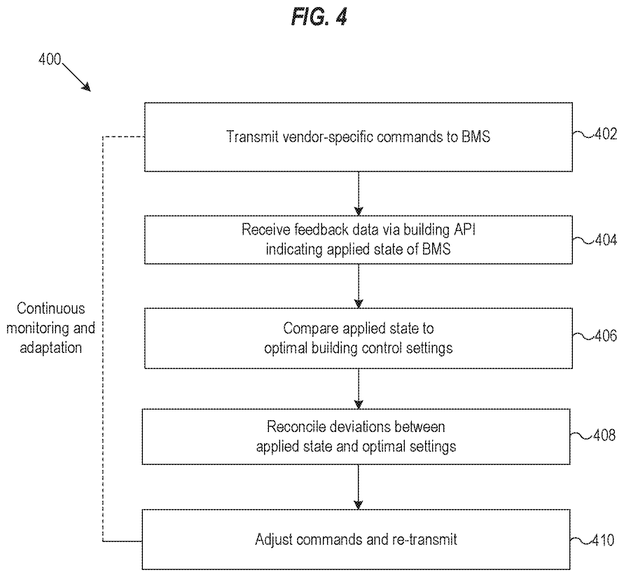

FIG. 4 is a flowchart depicting a continuous monitoring and adaptation process for building control settings, in accordance with an embodiment of the disclosure. FIG. 4 is explained in conjunction with elements from FIG. 1 and FIG. 2. With reference to FIG. 4, there is shown a flowchart 400. The flowchart 400 depicts a closed-loop feedback mechanism that reconciles deviations between applied building states and optimal control settings. The operations of the flowchart 400 may be executed by any computing system, for example, by the system 102 of FIG. 1. The flowchart 400 includes operations from 402 to 410.

At 402, the operations include transmitting vendor-specific commands to a building management system (BMS). As described above with reference to FIG. 2, the one or more virtual system controllers 130 translate vendor-neutral control commands into vendor-specific commands for the plurality of building management systems 106. The API call module 134 transmits the vendor-specific commands to the plurality of building management systems 106 via the communication network 136. The vendor-specific commands may adjust control points, schedules, and setpoints of a plurality of subsystems of the building 104 in real time.

At 404, the operations include receiving, via the building API, feedback data indicating an applied state of the plurality of building management systems 106 after the transmitting of the vendor-specific commands. The feedback data reflects the actual configuration of the building systems after the commands have been executed. The API call module 134 may receive the feedback data via read operations through the building API. The feedback data may comprise one or more of temperature readings, setpoint confirmations, equipment status indicators, or other operational parameters from the plurality of building management systems 106.

At 406, the operations include comparing the applied state to the optimal building control settings. The comparison identifies any discrepancies between the intended control settings determined by the one or more energy optimization applications/services 124 and the actual state of the building systems. For example, the system 102 may compare a commanded temperature setpoint of 72 °F to an applied setpoint of 70 °F reported by an HVAC controller to identify a deviation of 2 °F.

At 408, the operations include reconciling deviations between the applied state and the optimal building control settings. The reconciliation addresses any differences that may have occurred due to system limitations, communication delays, equipment constraints, or other factors that prevented the building systems from achieving the desired state. In some cases, the reconciliation may comprise adjusting the optimal building control settings to account for equipment capabilities or constraints. In some cases, the reconciliation may comprise generating corrective commands to bring the building systems closer to the optimal control settings.

At 410, the operations include adjusting commands and re-transmitting the adjusted commands to the plurality of building management systems 106. The adjusted commands account for the identified deviations and aim to bring the building systems closer to the optimal control settings. The API call module 134 transmits the adjusted commands to the plurality of building management systems 106 via the building API.

The flowchart 400 represents a continuous monitoring and adaptation process, as indicated by a return path from 410 back to 402. The continuous loop enables ongoing verification and correction of building control settings, ensuring that the building systems maintain alignment with the optimal configurations determined by the one or more energy optimization applications/services 124. The process provides a feedback mechanism that enhances the reliability of real-time building control by detecting and addressing discrepancies between commanded and applied states.

In some cases, the system 102 may detect an anomaly in the building data or the set of predictions during the continuous monitoring and adaptation process. The anomaly may comprise one or more of a sensor malfunction reporting implausible values, an unexpected occupancy pattern deviating from predictions, equipment operating outside expected parameters, or communication failures with building subsystems. In response to the detection of the anomaly, the system 102 may revert the optimal building control settings to a baseline policy to maintain safe and comfortable building conditions. The baseline policy may comprise predefined setpoints and schedules that provide acceptable building operation in the absence of optimization.

In some cases, the continuous monitoring and adaptation process may include comparing predicted outcomes to actual outcomes for energy consumption, occupant comfort, and equipment constraints. The comparison may be used to update model parameters and policies to improve accuracy and savings over time. For example, the system 102 may compare predicted energy consumption for a zone to actual metered consumption and adjust the one or more machine learning models 122 based on the deviation. The system 102 may also compare predicted occupancy to actual detected occupancy and refine the occupancy prediction models accordingly. This feedback loop may enable continuous improvement of the predictions and optimization outputs.

In some cases, the system 102 may implement safety and comfort constraints during the continuous monitoring and adaptation process. The safety and comfort constraints may comprise hard bounds on one or more of temperature, humidity, ventilation, and equipment cycling. The system 102 may enforce the safety and comfort constraints by preventing the optimal building control settings from exceeding the hard bounds. In some cases, the system 102 may implement policy conflict resolution when multiple optimization objectives or constraints conflict. In some cases, the system 102 may provide operator override capabilities that allow an operator to manually adjust building control settings, wherein the operator override may take precedence over the optimal building control settings determined by the one or more energy optimization applications/services 124.

In some cases, the one or more energy optimization applications/services 124 may support multi-objective optimization during the determination of the optimal building control settings. The multi-objective optimization may consider one or more of cost, carbon emissions, demand charges, demand peak reduction, comfort, and indoor air quality targets. The one or more energy optimization applications/services 124 may balance the multiple objectives based on configurable weights or priorities. For example, the one or more energy optimization applications/services 124 may reduce energy cost while maintaining indoor air quality above a threshold level and keeping temperature within a comfort range.

In some cases, the system 102 may integrate with demand response or grid-interactive building programs for coordination with utility grid operations. The integration may enable the system 102 to receive demand response signals from a utility or grid operator and adjust the optimal building control settings in response to the demand response signals. For example, the system 102 may reduce building load during a demand response event by adjusting temperature setpoints, dimming lighting, or discharging energy storage systems. The continuous monitoring and adaptation process may verify that the building systems respond appropriately to the demand response signals and reconcile any deviations from the requested load reduction.

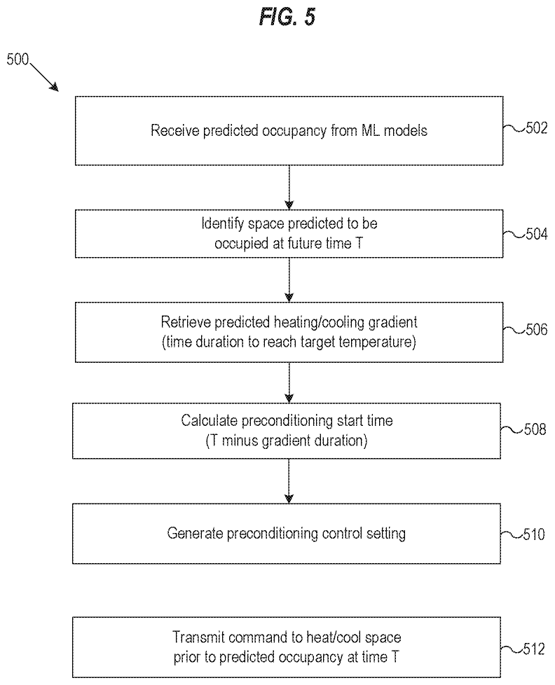

FIG. 5 is a flowchart depicting a preconditioning process based on predicted occupancy, in accordance with an embodiment of the disclosure. FIG. 5 is explained in conjunction with elements from FIG. 1 and FIG. 2. With reference to FIG. 5, there is shown a flowchart 500. The flowchart 500 demonstrates a sequential process that leverages machine learning predictions to proactively condition building spaces before occupants arrive. The operations of the flowchart 500 may be executed by any computing system, for example, by the system 102 of FIG. 1. The flowchart 500 includes operations from 502 to 512.

At 502, the operations include receiving predicted occupancy from the one or more machine learning models 122. As described above with reference to FIG. 2, the one or more machine learning models 122 generate a set of predictions comprising predicted occupancy at one or more spatial granularities. The predicted occupancy may be received at spatial granularities comprising one or more of meeting-room level granularities, region level granularities, floor level granularities, or building level granularities. The predicted occupancy may also be received at one or more temporal granularities comprising one or more of hourly, daily, or weekly granularity.

At 504, the operations include identifying, based on the predicted occupancy, a space predicted to be occupied at a future time T. The one or more energy optimization applications/services 124 may analyze the predicted occupancy to identify spaces within the building 104 that are predicted to transition from an unoccupied state to an occupied state at the future time T. For example, the one or more energy optimization applications/services 124 may identify a conference room predicted to be occupied at 2:00 PM based on predicted occupancy patterns or calendar data indicating a scheduled meeting.

At 506, the operations include retrieving a predicted heating or cooling gradient. The predicted heating or cooling gradient represents a time duration to reach a target temperature for the identified space. As described above with reference to FIG. 2, the one or more machine learning models 122 generate predicted heating or cooling gradients based on environmental conditions, thermal properties, and occupancy data. The predicted heating or cooling gradient may indicate, for example, that heating a particular zone from a setback temperature to a comfort temperature requires 45 minutes based on the thermal properties of the zone, current outdoor temperature, and expected occupancy heat load.

At 508, the operations include calculating a preconditioning start time by subtracting the gradient duration from the future time T. The one or more energy optimization applications/services 124 may calculate the preconditioning start time to ensure that the identified space reaches the target temperature by the future time T when occupancy is predicted. For example, if the future time Tis 2:00 PM and the predicted heating gradient indicates a 45-minute duration to reach the target temperature, the preconditioning start time may be calculated as 1:15 PM.

At 510, the operations include generating a preconditioning control setting to heat or cool the space prior to the future time T based on the predicted heating or cooling gradients. The one or more energy optimization applications/services 124 generate the preconditioning control setting based on the calculated preconditioning start time and the target temperature for the identified space. The preconditioning control setting may comprise a temperature setpoint and a start time for heating or cooling operations.

At 512, the operations include transmitting a command to heat or cool the space prior to the predicted occupancy at the future time T. The one or more virtual system controllers 130 generate vendor-neutral control commands based on the preconditioning control setting and translate the vendor-neutral control commands into vendor-specific commands for the plurality of building management systems 106. The API call module 134 transmits the vendor-specific commands to the plurality of building management systems 106 via the building API to initiate heating or cooling of the identified space at the calculated preconditioning start time.

The flowchart 500 demonstrates a process that ensures comfort while optimizing energy usage by avoiding heating or cooling of unoccupied spaces. By leveraging predicted occupancy and predicted heating or cooling gradients, the system 102 may precondition spaces to reach target temperatures at the time occupants are predicted to arrive, rather than maintaining comfort temperatures in spaces that are unoccupied.

In some cases, the external data may further comprise calendar data and schedule data associated with occupants of the building 104. The determining of the optimal building control settings may comprise receiving an occupancy indication from a calendar application associated with an occupant of the building 104. The occupancy indication may comprise one or more of a scheduled meeting location, an in-office indication, or an out-of-office indication. The one or more energy optimization applications/services 124 may generate a control setting to adjust heating or cooling in a space associated with the occupant based on the occupancy indication. For example, the system 102 may link spatial controls to an occupant's calendar application such that an out-of-office indication may trigger adjustment of room controls, and the system 102 may restore conditions prior to a scheduled return based on preconditioning time estimates derived from the predicted heating or cooling gradients.

In some cases, the system 102 may partner with providers to determine feasibility of influencing organizational behavior such as co-locating individuals or groups based on energy use profile for additional savings. The preconditioning process may be coordinated with organizational scheduling to concentrate occupancy in fewer zones during periods of low overall building utilization, thereby reducing the number of spaces that require preconditioning.

In some cases, the system architecture may be expanded to support vertical abstractions beyond energy including space utilization, occupant productivity, workforce productivity, location-based responses, privacy-preservation, and security coordination. The preconditioning process may be integrated with space utilization analytics to identify underutilized spaces that may be consolidated, or with security coordination to align preconditioning schedules with building access policies.

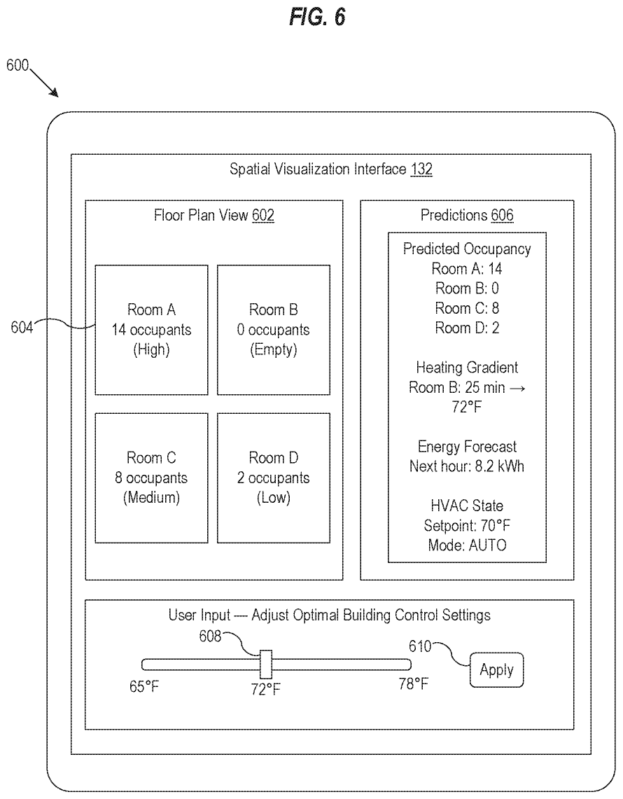

FIG. 6 is a diagram that illustrates a spatial visualization interface 132 for building energy and performance optimization, in accordance with an embodiment of the disclosure. FIG. 6 is explained in conjunction with elements from FIG. 1. With reference to FIG. 6, the spatial visualization interface 132 is displayed on a computing device 600. The computing device 600 may be any device capable of displaying the spatial visualization interface 132 and receiving user input. Examples of the computing device 600 may include, but are not limited to, a desktop computer, a laptop computer, a tablet computer, a smartphone, or a dedicated building management terminal.

The spatial visualization interface 132 includes a floor plan view 602 that displays a plurality of zones 604 representing different rooms or areas within the building 104. Each zone within the plurality of zones 604 may show occupancy information including the number of occupants and an occupancy level indicator such as High, Medium, Low, or Empty. The floor plan view 602 provides a spatial representation of the building 104 that enables operators to visualize current building conditions and predicted states across different areas.

The spatial visualization interface 132 further includes a predictions display 606 that presents the set of predictions and the building data. The predictions display 606 may present predicted occupancy data for each room, heating gradient information indicating time to reach a target temperature, energy forecast data showing predicted energy consumption, and HVAC state information including setpoint and mode settings. As described above with reference to FIG. 2, the one or more machine learning models 122 generate the set of predictions comprising one or more of predicted occupancy at one or more spatial granularities, predicted heating or cooling gradients based on environmental conditions, thermal properties, and occupancy data, or predicted energy consumption patterns. The spatial visualization interface 132 displays the set of predictions and the building data via the predictions display 606.

The spatial visualization interface 132 includes a setpoint control 608 that allows a user to adjust optimal building control settings. The setpoint control 608 may enable a user to select a temperature value along a range. For example, the setpoint control 608 may display a range from 65 °F to 78 °F, with a current selection shown at a particular temperature value such as 72 °F. The spatial visualization interface 132 receives, via the setpoint control 608, a user input to adjust the optimal building control settings.

An apply button 610 is positioned adjacent to the setpoint control 608 to enable the user to confirm and apply the adjusted settings to the plurality of building management systems 106. When the user selects the apply button 610, the system 102 transmits the adjusted optimal building control settings to the one or more virtual system controllers 130, which generate vendor-neutral control commands based on the adjusted settings and translate the vendor-neutral control commands into vendor-specific commands for transmission to the plurality of building management systems 106 via the API call module 134.

The spatial visualization interface 132 depicted in FIG. 6 is an exemplary implementation and should not be construed as limiting the disclosure. The visual arrangement, specific labels, and user interface elements may vary in different implementations while still achieving the functionality described herein. Other dashboard configurations, floor plan presentations, predictions display formats, and setpoint control presentations may be employed without departing from the scope of the disclosure. In some cases, the system 102 may support headless operation without the spatial visualization interface 132, wherein the system 102 operates autonomously or via programmatic interfaces without requiring a graphical user interface for visualization or operator interaction.

In some cases, the system 102 may generate one or more behavioral incentives 128 based on the set of predictions. The one or more behavioral incentives 128 may comprise one or more of targeted notifications, goal tracking, gamification elements, or credits. The system 102 may transmit the one or more behavioral incentives 128 to one or more devices associated with occupants of the building 104, such as the occupant devices 116, to encourage alignment with the optimal building control settings. For example, the system 102 may transmit a notification to the occupant devices 116 encouraging an occupant to adjust personal preferences to align with building-wide optimization goals, or may provide energy credits to occupants who participate in demand reduction programs.

In some cases, the system 102 may coordinate distributed energy resources 112 across multiple buildings in a portfolio. The system 102 may train building-specific models for each building in the portfolio and coordinate the distributed energy resources 112 across the multiple buildings. The spatial visualization interface 132 may report aggregated savings and performance indicators across the portfolio. The aggregated savings may represent energy cost reductions achieved across the multiple buildings, and the performance indicators may comprise metrics such as energy consumption, demand reduction, or comfort compliance across the portfolio.

FIG. 7 is a block diagram illustrating a system for building energy and performance optimization, in accordance with an embodiment of the disclosure. FIG. 7 is explained in conjunction with elements from FIGS. 1-6. With reference to FIG. 7, there is shown a block diagram 700 of the system 102. The system 102 includes the one or more processors 702, the memory 704, a network interface 706, an Input/Output (I/O) interface 708, and the persistent storage 710. The one or more processors 702, the memory 704, the network interface 706, the I/O interface 708, and the persistent storage 710 are interconnected via a bus 712.

The one or more processors 702 may include suitable logic, circuitry, and interfaces configured to execute program instructions and perform computational operations for the system 102. The one or more processors 702 may be configured to execute program instructions associated with building energy and performance optimization operations. The one or more processors 702 may include any suitable special-purpose or general-purpose computer, computing entity, or processing device including various computer hardware or software modules and may be configured to execute instructions stored on any applicable computer-readable storage media. For example, the one or more processors 702 may include a microprocessor, a microcontroller, a digital signal processor (DSP), an application-specific integrated circuit (ASIC), a Field-Programmable Gate Array (FPGA), or any other digital or analog circuitry configured to interpret and execute program instructions and process data. The one or more processors 702 may include any number of processors configured to, individually or collectively, perform or direct performance of any number of operations of the system 102, as described in the present disclosure.

The one or more processors 702 may be configured to receive, via a building application programming interface (API), building data from a plurality of building management systems and sensor networks associated with a building. The one or more processors 702 may be configured to store the building data in a data lake. The one or more processors 702 may be configured to transform, by a data management middleware, the building data into semantic observations, the semantic observations comprising one or more of occupancy data, location data, and activity data. The one or more processors 702 may be configured to generate, by one or more machine learning models trained on the semantic observations, a set of predictions comprising one or more of: predicted occupancy at one or more spatial granularities, predicted heating or cooling gradients based on environmental conditions, thermal properties, and occupancy data, or predicted energy consumption patterns. The one or more processors 702 may be configured to determine, by one or more energy optimization applications/services, optimal building control settings based on the set of predictions and external data comprising one or more of utility pricing data and weather data. The one or more processors 702 may be configured to generate, by one or more virtual system controllers, vendor-neutral control commands based on the optimal building control settings. The one or more processors 702 may be configured to translate the vendor-neutral control commands into vendor-specific commands for the plurality of building management systems. The one or more processors 702 may be configured to transmit, via the building API, the vendor-specific commands to the plurality of building management systems.

The memory 704 may include suitable logic, circuitry, and interfaces configured to store program instructions executable by the one or more processors 702. The memory 704 may be configured to provide temporary storage for data and instructions being actively processed by the one or more processors 702. The memory 704 may include computer-readable storage media for carrying or having computer-executable instructions or data structures stored thereon. Such computer-readable storage media may include any available media that may be accessed by a general-purpose or special-purpose computer, such as the one or more processors 702. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), or flash memory devices. The memory 704 may store instructions that, when executed by the one or more processors 702, cause the system 102 to perform building energy and performance optimization operations, including receiving building data, transforming the building data into semantic observations, generating predictions using machine learning models, determining optimal building control settings, and transmitting vendor-specific commands to building management systems.

The network interface 706 may include suitable logic, circuitry, and interfaces configured to enable the system 102 to communicate with external devices and networks. The network interface 706 may establish communication between the system 102 and the plurality of building management systems 106, the sensor networks 108, the Wi-Fi infrastructure 110, the distributed energy resources 112, the external data sources 114, and the occupant devices 116 through the communication network 136. The network interface 706 may be implemented using various technologies to support wired or wireless communication of the system 102. The network interface 706 may include, but is not limited to, an antenna, a radio frequency (RF) transceiver, one or more amplifiers, a tuner, one or more oscillators, a digital signal processor, a coder-decoder (CODEC) chipset, or a network interface card. The network interface 706 may communicate via wireless communication with networks, such as the Internet, an Intranet, or a wireless network. The network interface 706 may facilitate reception of building data from the plurality of building management systems 106 and transmission of vendor-specific commands to the plurality of building management systems 106 via the building API.

The I/O interface 708 may include suitable logic, circuitry, and interfaces configured to facilitate input and output operations for the system 102. The I/O interface 708 may allow the system 102 to interact with peripheral devices and users. The I/O interface 708 may include various input and output devices configured to communicate with the one or more processors 702 and other components of the system 102. Examples of input devices may include, but are not limited to, a touch screen, a keyboard, a mouse, a joystick, and a microphone. Examples of output devices may include, but are not limited to, a display and a speaker. The I/O interface 708 may support connections to displays for presenting the spatial visualization interface 132, as well as input devices for receiving user commands and adjustments to building control settings.

The persistent storage 710 may include suitable logic, circuitry, and interfaces configured to provide non-volatile storage for data, program instructions, and other information that persists when the system 102 is powered off. The persistent storage 710 may store program instructions executable by the one or more processors 702, operating systems, and application-specific information. The persistent storage 710 may include computer-readable storage media for carrying or having computer-executable instructions or data structures stored thereon. By way of example, and not limitation, such computer-readable storage media may include tangible or non-transitory computer-readable storage media including Compact Disc Read-Only Memory (CD-ROM) or other optical disk storage, magnetic disk storage or other magnetic storage devices, solid-state drives, flash memory devices, or any other storage medium which may be used to carry or store particular program code in the form of computer-executable instructions or data structures. The persistent storage 710 may store the data lake 118 containing building data, trained machine learning models, semantic observations, historical predictions, and configuration data for the plurality of building management systems 106.

The bus 712 may provide communication pathways between all components of the system 102. The bus 712 may connect the one or more processors 702, the memory 704, the network interface 706, the I/O interface 708, and the persistent storage 710, enabling bidirectional data exchange between these components. The bus 712 may support data transfer operations for building energy and performance optimization workflows, including transfer of building data, semantic observations, predictions, optimal building control settings, and vendor-specific commands between the one or more processors 702, the memory 704, and the persistent storage 710.

In some aspects, the block diagram 700 may be applicable to the other devices of the network environment 100 such as the occupant devices. Each occupant device may include a processor, memory, a network interface, an I/O interface, and persistent storage interconnected via a bus.

Modifications, additions, or omissions may be made to the system 102 without departing from the scope of the present disclosure. For example, in some embodiments, the system 102 may include any number of other components that may not be explicitly illustrated or described.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method for building energy and performance optimization, the computer-implemented method comprising:
receiving, via a building application programming interface (API), building data from a plurality of building management systems and sensor networks associated with a building;
storing the building data in a data lake;
transforming, by a data management middleware, the building data into semantic observations, the semantic observations comprising one or more of occupancy data, location data, and activity data;
generating, by one or more machine learning models trained on the semantic observations, a set of predictions comprising one or more of:
predicted occupancy at one or more spatial granularities,
predicted heating or cooling gradients based on environmental conditions, thermal properties, and occupancy data, or
predicted energy consumption patterns;
determining, by one or more energy optimization applications/services, optimal building control settings based on the set of predictions and external data comprising one or more of utility pricing data and weather data;
generating, by one or more virtual system controllers, vendor-neutral control commands based on the optimal building control settings;
translating the vendor-neutral control commands into vendor-specific commands for the plurality of building management systems; and
transmitting, via the building API, the vendor-specific commands to the plurality of building management systems.

2. The computer-implemented method of claim 1, wherein the vendor-specific commands are transmitted to adjust control points, schedules, and setpoints of a plurality of subsystems of the building in real time.

3. The computer-implemented method of claim 1, wherein the building data comprises data from existing building networks comprising a Wi-Fi infrastructure, and wherein the transforming of the building data into semantic observations comprises:
receiving Wi-Fi connectivity data from the Wi-Fi infrastructure; and
converting the Wi-Fi connectivity data into occupancy counts at a spatial granularity comprising one or more of room-level, region-level, and floor-level granularity.

4. The computer-implemented method of claim 1, wherein the one or more machine learning models comprise one or more of a long short-term memory (LSTM) network, a convolutional neural network (CNN), a graph neural network (GNN), or a transformer architecture, and
wherein the one or more machine learning models are self-tuning models that learn building-specific behavior based on characteristics of the building comprising one or more of location, orientation, physical characteristics, and usage patterns.

5. The computer-implemented method of claim 1, wherein the generating of the set of predictions comprises:
generating the predicted occupancy at the one or more spatial granularities comprising one or more of meeting-room level granularities, region level granularities, floor level granularities, or building level granularities; and
generating the predicted occupancy at one or more temporal granularities comprising one or more of hourly, daily, or weekly granularity.

6. The computer-implemented method of claim 1, wherein the generating of the set of predictions comprises determining time duration to heat or cool a region of the building to a target temperature, wherein the determination of the time duration is based on heating, ventilation, and air conditioning (HVAC) data, the environmental conditions, and the occupancy data.

7. The computer-implemented method of claim 1, wherein the external data further comprises calendar data and schedule data associated with occupants of the building, and wherein the determining of the optimal building control settings comprises:
receiving an occupancy indication from a calendar application associated with an occupant of the building, the occupancy indication comprising one or more of a scheduled meeting location, an in-office indication, or an out-of-office indication; and
generating a control setting to adjust heating or cooling in a space associated with the occupant based on the occupancy indication.

8. The computer-implemented method of claim 1, wherein the utility pricing data comprises time-of-use pricing data, and wherein the determining of the optimal building control settings comprises:
identifying a peak pricing period and an off-peak pricing period based on the time-of-use pricing data;
generating control settings to charge an energy storage system during the off-peak pricing period and discharge the energy storage system during the peak pricing period;
receiving solar generation data from a solar panel system associated with the building; and
generating control settings, based on the solar generation data, to charge the energy storage system during periods of solar generation.

9. The computer-implemented method of claim 1, wherein the building API provides bidirectional communication with the plurality of building management systems, and the bidirectional communication comprises:
a read operation to receive the building data from the plurality of building management systems; and
a write operation to transmit the vendor-specific commands to the plurality of building management systems.

10. The computer-implemented method of claim 1, wherein the building data is received from a plurality of building management systems that control one or more of a heating, ventilation, and air conditioning (HVAC) system, a lighting system, a water heating system, or a refrigeration system.

11. The computer-implemented method of claim 1, wherein the building data comprises multimodal sensor data comprising one or more of sensor data, device data, actuator data, camera data, motion sensor data, door open/close sensor data, and HVAC data, and wherein the method further comprises:
receiving additional data from a plurality of management systems; and
updating the one or more machine learning models based on the additional data.

12. The computer-implemented method of claim 1, wherein the transforming of the building data into the semantic observations comprises applying, by the data management middleware, one or more privacy-preserving techniques comprising one or more of randomization, anonymization, scrubbing, policy-based access, encryption, and differential privacy to the building data.

13. The computer-implemented method of claim 1, further comprising:
displaying, via a spatial visualization interface, the set of predictions and the building data; and
receiving, via the spatial visualization interface, a user input to adjust the optimal building control settings.

14. The computer-implemented method of claim 1, further comprising:
receiving, via the building API, feedback data indicating an applied state of the plurality of building management systems after the transmitting of the vendor-specific commands;
comparing the applied state to the optimal building control settings; and
reconciling deviations between the applied state and the optimal building control settings.

15. The computer-implemented method of claim 1, further comprising:
detecting an anomaly in the building data or the set of predictions; and
reverting, in response to the detection of the anomaly, the optimal building control settings to a baseline policy.

16. The computer-implemented method of claim 1, further comprising:
generating one or more behavioral incentives based on the set of predictions, the one or more behavioral incentives comprising one or more of targeted notifications, goal tracking, gamification elements, or credits; and
transmitting the one or more behavioral incentives to one or more devices associated with occupants of the building to encourage alignment with the optimal building control settings.

17. The computer-implemented method of claim 1, wherein the determining of the optimal building control settings comprises:
identifying, based on the predicted occupancy, a space predicted to be occupied at a future time; and
generating a preconditioning control setting to heat or cool the space prior to the future time based on the predicted heating or cooling gradients.

18. The computer-implemented method of claim 1, wherein the set of predictions further comprises a predicted state-of-charge of a distributed energy resource associated with the building, and wherein the determining of the optimal building control settings is further based on the predicted state-of-charge.

19. A system for building energy and performance optimization, the system comprising:
one or more processors; and
a memory storing instructions that, when executed by the one or more processors, cause the system to:
receive, via a building application programming interface (API), building data from a plurality of building management systems and sensor networks associated with a building;
store the building data in a data lake;
transform, by a data management middleware, the building data into semantic observations, the semantic observations comprising one or more of occupancy data, location data, and activity data;
generate, by one or more machine learning models trained on the semantic observations, a set of predictions comprising one or more of:
predicted occupancy at one or more spatial granularities,
predicted heating or cooling gradients based on environmental conditions, thermal properties, and occupancy data, or
predicted energy consumption patterns;
determine, by one or more energy optimization applications/services, optimal building control settings based on the set of predictions and external data comprising one or more of utility pricing data and weather data;
generate, by one or more virtual system controllers, vendor-neutral control commands based on the optimal building control settings;
translate the vendor-neutral control commands into vendor-specific commands for the plurality of building management systems; and
transmit, via the building API, the vendor-specific commands to the plurality of building management systems.

20. A non-transitory computer-readable storage medium with program instructions stored thereon, the program instructions when executed by one or more processors are operable to cause the one or more processors to perform operations comprising:
receiving, via a building application programming interface (API), building data from a plurality of building management systems and sensor networks associated with a building;
storing the building data in a data lake;
transforming, by a data management middleware, the building data into semantic observations, the semantic observations comprising one or more of occupancy data, location data, and activity data;
generating, by one or more machine learning models trained on the semantic observations, a set of predictions comprising one or more of:
predicted occupancy at one or more spatial granularities,
predicted heating or cooling gradients based on environmental conditions, thermal properties, and occupancy data, or
predicted energy consumption patterns;
determining, by one or more energy optimization applications/services, optimal building control settings based on the set of predictions and external data comprising one or more of utility pricing data and weather data;
generating, by one or more virtual system controllers, vendor-neutral control commands based on the optimal building control settings;
translating the vendor-neutral control commands into vendor-specific commands for the plurality of building management systems; and
transmitting, via the building API, the vendor-specific commands to the plurality of building management systems.
